(19) United States
(12) Patent Application Publication
(10) Pub. No.: US 2025/0020984 A1
(43) Pub. Date: Jan. 16, 2025

(54) ILLUMINATION SYSTEM AND PROJECTION DEVICE

(71) Applicant: Coretronic Corporation, Hsin-Chu (TW)

(72) Inventor: Chang-Hsuan Chen, Hsin-Chu (TW)

(73) Assignee: Coretronic Corporation, Hsin-Chu (TW)

(21) Appl. No.: 18/765,313

(22) Filed: Jul. 7, 2024

(30) Foreign Application Priority Data
Jul. 11, 2023 (CN) 202310842496.6

(51) Int. Cl. G03B 21/20; G02B 26/00

(52) U.S. Cl. CPC G03B 21/204; G02B 26/008; G03B 21/2066

(57) ABSTRACT

An illumination system including a light source module, a plurality of optical elements and a wavelength conversion element is provided. The optical elements include a light-splitting element and at least one lens, which is located between the light-splitting element and the wavelength conversion element. At least one of the optical elements includes a body and a light-absorbing structure. When the laser beam is incident to the body, a light spot is formed on the body, and a region where the light spot is located is defined as a first region. The first region is located at one side of a central axis of the body. Another side of the central axis of the body has a second region, wherein the light-absorbing structure is distributed on at least a part of an edge of the body, and the at least a part is adjacent to the second region.

### CROSS-REFERENCE TO RELATED APPLICATION

This application claims the priority benefit of China application serial no. 202310842496.6, filed on Jul. 11, 2023. The entirety of the above-mentioned patent application is hereby incorporated by reference herein and made a part of this specification.

### BACKGROUND

### Technical Field

The invention relates to an optical system and an electronic device, and particularly relates to an illumination system and a projection device.

### Description of Related Art

Projection device is a display device used to produce large-size images, and has been constantly improved along with evolution and innovation of science and technology. An imaging principle of the projection device is to convert an illumination beam generated by an illumination system into an image beam through a light valve, and then project the image beam onto a projection target (such as a screen or wall) through a projection lens to form a projection image. In addition, along with market's demands on brightness, color saturation, service life, non-toxic and environmental protection, etc., of the projection device, the illumination system has also evolved from ultra-high-performance lamps (UHP lamps), light-emitting diodes (LED) to the most advanced laser diode (LD) light sources, and even a packaged light source formed by multi-in-one laser diodes has been released to make an internal configuration of the projection device more compact and improve an optical performance thereof.

In a current optical system, a light beam is focused on a wavelength conversion color wheel after passing through various optical elements. In order to ensure a better optical performance of the optical system, glass is chosen as a main material. However, when the glass is irradiated by the light beam, a center temperature of the glass is likely to increase, and an edge temperature is relatively low, which in turn leads to imbalanced tensile stress, resulting in easy breakage of the glass.

The information disclosed in the Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to an illumination system and a projection device, which are adapted to prevent optical elements from breaking due to a temperature difference, improve stability of the optical elements, thereby achieving good optical quality.

Additional aspects and advantages of the present invention will be set forth in the description of the techniques disclosed in the present invention.

In order to achieve one or a portion of or all of the objects or other objects, an embodiment of the invention provides an illumination system including a light source module, a plurality of optical elements and a wavelength conversion element. The light source module is configured to provide a laser beam. The plurality of optical elements are disposed on a transmission path of the laser beam and are located between the light source module and the wavelength conversion element, wherein the plurality of optical elements include a light-splitting element and at least one lens. Wherein, the at least one lens is located between the light-splitting element and the wavelength conversion element. The light-splitting element is disposed on the transmission path of the laser beam to guide the laser beam to the at least one lens, the laser beam passes through the at least one lens and is then transmitted to the wavelength conversion element. The wavelength conversion element is disposed on the transmission path of the laser beam from the at least one lens, and is configured to reflect the laser beam back to the light-splitting element and convert the laser beam into an excited beam and then reflect the excited beam back to the light-splitting element. At least one of the light-splitting element and the at least one lens includes a body and a light-absorbing structure. When the laser beam is incident to the body, a light spot is formed on the body, and a region where the light spot is located is defined as a first region. The first region is located at one side of a central axis of the body. Another side of the central axis of the body has a second region, wherein the light-absorbing structure is distributed on at least a part of an edge of the body, and the at least a part is adjacent to the second region.

In order to achieve one or a portion of or all of the objects or other objects, an embodiment of the invention provides an illumination system including a light source module, a plurality of optical elements, a wavelength conversion element and a light-uniformizing element. The light source module is configured to provide a laser beam. The plurality of optical elements are disposed on a transmission path of the laser beam and are located between the light source module and the wavelength conversion element, wherein the plurality of optical elements include a light-splitting element and a lens group. Wherein, the lens group includes at least one first lens, at least one second lens and at least one third lens, wherein the at least one first lens is located between the light-splitting element and the wavelength conversion element. The at least one second lens is located between the light source module and the light-splitting element. The at least one third lens is located between the light-splitting element and the light-uniformizing element. The light-splitting element is disposed on the transmission path of the laser beam to guide the laser beam passing through the at least one second lens to the at least one first lens. The laser beam passes through the at least one first lens and is then transmitted to the wavelength conversion element. The wavelength conversion element is disposed on the transmission path of the laser beam from the at least one first lens, and is configured to allow the laser beam to pass through and convert the laser beam into an excited beam and then reflect the excited beam back to the light-splitting element. The light-splitting element then guides the excited light beam to the at least one third lens and then to the light-uniformizing element. Wherein, at least one of the light-splitting element and the lens group includes a body and a light-absorbing structure, and when the laser beam is incident to the body, a light spot is formed on the body, and a region where the light spot is located is defined as a first region, wherein a central axis of the body passes through the first region, and the light-absorbing structure is distributed on an edge of the body away from the first region.

In order to achieve one or a portion of or all of the objects or other objects, an embodiment of the invention provides a projection device including an illumination system, a light valve and a projection lens. The illumination system is configured to provide an illumination beam, the illumination system includes a light source module, a plurality of optical elements and a wavelength conversion element. The light source module is configured to provide a laser beam. The plurality of optical elements are disposed on a transmission path of the laser beam and are located between the light source module and the wavelength conversion element, wherein the plurality of optical elements include a light-splitting element and at least one lens. Wherein, the at least one lens is located between the light-splitting element and the wavelength conversion element. The light-splitting element is disposed on the transmission path of the laser beam to guide the laser beam to the at least one lens, the laser beam passes through the at least one lens and is then transmitted to the wavelength conversion element. The wavelength conversion element is disposed on the transmission path of the laser beam from the at least one lens, and is configured to reflect the laser beam back to the light-splitting element and convert the laser beam into an excited beam and then reflect the excited beam back to the light-splitting element. At least one of the light-splitting element and the at least one lens includes a body and a light-absorbing structure. When the laser beam is incident to the body, a light spot is formed on the body, and a region where the light spot is located is defined as a first region. The first region is located at one side of a central axis of the body. Another side of the central axis of the body has a second region, wherein the light-absorbing structure is distributed on at least a part of an edge of the body, and the at least a part is adjacent to the second region. The light valve is disposed on a transmission path of the illumination beam to convert the illumination beam into an image beam. The projection lens is disposed on a transmission path of the image beam and is configured to project the image beam out of the projection device.

In order to achieve one or a portion of or all of the objects or other objects, an embodiment of the invention provides another projection device including an illumination system, a light valve and a projection lens. The illumination system is configured to provide an illumination beam, the illumination system includes a light source module, a plurality of optical elements, a wavelength conversion element and a light-uniformizing element. The light source module is configured to provide a laser beam. The plurality of optical elements are disposed on a transmission path of the laser beam and are located between the light source module and the wavelength conversion element, wherein the plurality of optical elements include a light-splitting element and a lens group. Wherein, the lens group includes at least one first lens, at least one second lens and at least one third lens, wherein the at least one first lens is located between the light-splitting element and the wavelength conversion element. The at least one second lens is located between the light source module and the light-splitting element. The at least one third lens is located between the light-splitting element and the light-uniformizing element. The light-splitting element is disposed on the transmission path of the laser beam to guide the laser beam passing through the at least one second lens to the at least one first lens. The laser beam passes through the at least one first lens and is then transmitted to the wavelength conversion element. The wavelength conversion element is disposed on the transmission path of the laser beam from the at least one first lens, and is configured to allow the laser beam to pass through and convert the laser beam into an excited beam and then reflect the excited beam back to the light-splitting element. The light-splitting element then guides the excited light beam to the at least one third lens and then to the light-uniformizing element. Wherein, at least one of the light-splitting element and the lens group includes a body and a light-absorbing structure, and when the laser beam is incident to the body, a light spot is formed on the body, and a region where the light spot is located is defined as a first region, wherein a central axis of the body passes through the first region, and the light-absorbing structure is distributed on an edge of the body away from the first region. The light valve is disposed on a transmission path of the illumination beam to convert the illumination beam into an image beam. The projection lens is disposed on a transmission path of the image beam and is configured to project the image beam out of the projection device.

Based on the above, embodiments of the invention have at least one of the following advantages or effects. In the illumination system and projection device of the invention, the illumination system includes a light source module, a plurality of optical elements and a wavelength conversion element. The plurality of optical elements includes a light-splitting element and at least one lens, and at least one of the plurality of optical elements includes a body and a light-absorbing structure, and the light-absorbing structure is distributed on at least a part of the edge of the body. In this way, the light-absorbing structure may absorb stray light and increase a temperature of the corresponding edge, thereby preventing the optical element from cracking due to the temperature difference, and improving stability of the optical elements and achieving good optical quality.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to an embodiment of the invention.

FIG. 2 is a schematic diagram of an illumination system according to an embodiment of the invention.

FIG. 3 is a schematic diagram of a light-splitting element according to an embodiment of the invention.

FIG. 4A to FIG. 4C are schematic diagrams of light-absorbing structures on a body according to different embodiments of the invention.

FIG. 5A is a schematic diagram of a light converging lens according to an embodiment of the invention.

FIG. 5B is a schematic diagram of another light converging lens according to an embodiment of the invention.

FIG. 6 is a schematic diagram of a collimating lens according to an embodiment of the invention.

FIG. 7 is a schematic diagram of an illumination system according to another embodiment of the invention.

FIG. 8 is a schematic diagram of a light-splitting element according to another embodiment of the invention.

FIG. 9 is a schematic diagram of a light converging lens according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

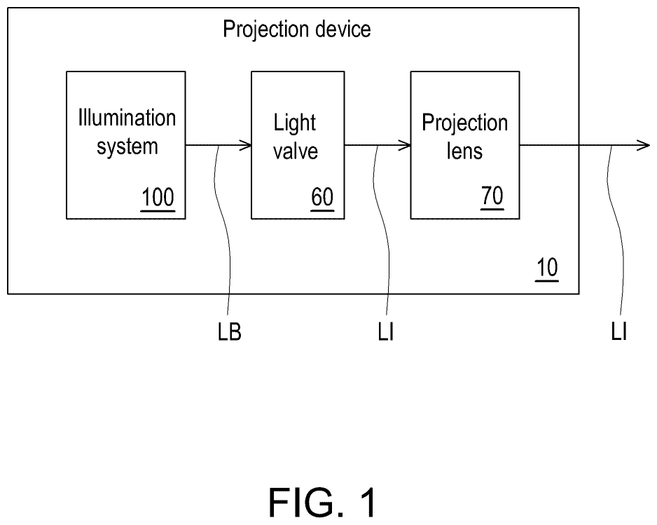

FIG. 1 is a schematic diagram of a projection device according to an embodiment of the invention. Referring to FIG. 1, the embodiment provides a projection device 10 including an illumination system 100, a light valve 60 and a projection lens 70. Where, the illumination system 100 is configured to provide an illumination beam LB. The light valve 60 is disposed on a transmission path of the illumination beam LB to convert the illumination beam LB into an image beam LI. The projection lens 70 is disposed on a transmission path of the image beam LI, and is configured to project the image beam LI out of the projection device 10 to a projection target (not shown), such as a screen or a wall.

The illumination system 100 is configured to provide the illumination beam LB. In detail, in the embodiment, the illumination system 100 is configured to provide light of different wavelengths through at least one light-emitting element to form the image beam LI. The light-emitting element is, for example, a light-emitting diode (LED) or a laser diode (LD). However, the invention does not limit a type or form of the illumination system 100 in the projection device 10, and sufficient teachings, suggestions and implementation instructions of detailed optical structure and implementation of the illumination system 100 may be obtained from common knowledge in the technical field, which are not repeated.

The light valve 60 is, for example, a reflective optical modulator such as a liquid crystal on silicon panel (LCoS panel) or a digital micro-mirror device (DMD). In some embodiments, the light valve 60 may also be a transmissive optical modulator such as a transparent liquid crystal panel, an electro-optical modulator, a magneto-optic modulator, or an acousto-optic modulator (AOM), etc. The invention does not limit the type and form of the light valve 60. Regarding a method for the light valve 60 to convert the illumination beam LB into the image beam LI, sufficient teachings, suggestions and implementation instructions of detailed steps and implementation thereof may be obtained from the common knowledge in the technical field. In the embodiment, a number of the light valve 60 is one, for example, the projection device 10 uses a single digital micro-mirror element, but in other embodiments, there may be multiple light valves, which is not limited by the invention.

The projection lens 70 includes, for example, a combination of one or more optical lenses with refractive power, for example, includes various combinations of non-planar lenses such as biconcave lenses, biconvex lenses, concavo-convex lenses, convexo-concave lenses, plano-convex lenses, plano-concave lenses, etc. In an embodiment, the projection lens 70 may further include a planar optical lens to project the image beam LI from the light valve 60 to the projection target in a reflective manner. The invention does not limit the type and form of the projection lens 70.

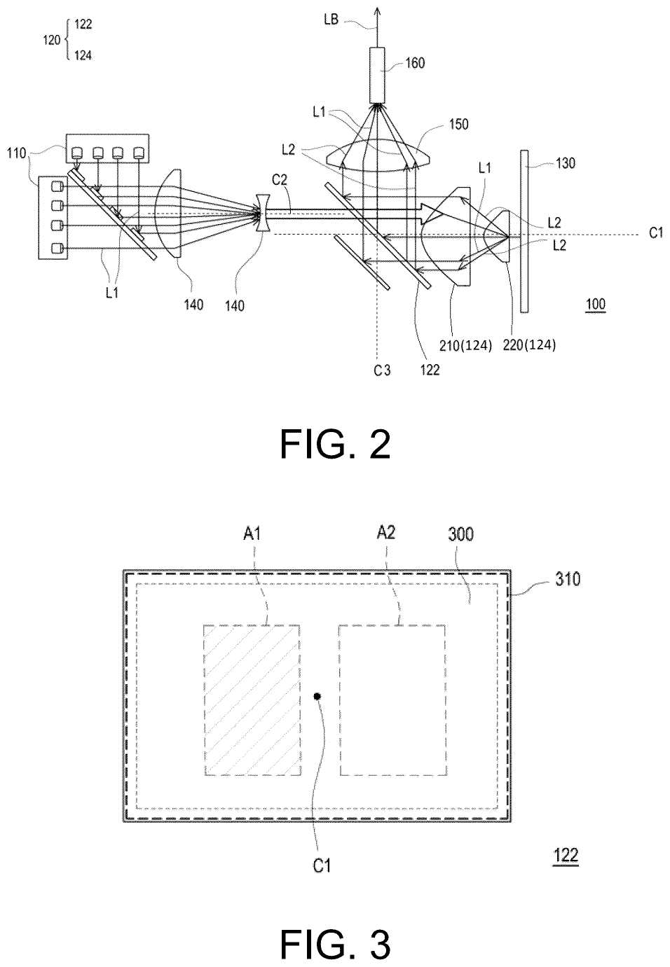

FIG. 2 is a schematic diagram of an illumination system according to an embodiment of the invention. Referring to FIG. 2, the illumination system 100 shown in FIG. 2 may be applied to at least the projection device 10 shown in FIG. 1, which is taken as an example for description. In the embodiment, the illumination system 100 includes a light source module 110, a plurality of optical elements 120 and a wavelength conversion element 130. Where, the light source module 110 is configured to provide a laser beam L1. The light source module 110 includes, for example, a plurality of laser diodes (LDs). For example, in the embodiment, the plurality of laser diodes are blue laser diodes, which provide a blue laser beam L1.

A plurality of optical elements 120 are disposed on a transmission path of the laser beam L1 and are located between the light source module 110 and the wavelength conversion element 130. The plurality of optical elements 120 include a light-splitting element 122 and at least one lens 124, where the at least one lens 124 is located between the light-splitting element 122 and the wavelength conversion element 130. In other words, the at least one lens 124 is a light converging lens disposed between the light-splitting element 122 and the wavelength conversion element 130 to focus the laser beam LI to the wavelength conversion element 130. The at least one lens 124 includes a first sub-lens 210 and/or a second sub-lens 220. For example, in the embodiment, the at least one lens 124 is two lenses, including the first sub-lens 210 and the second sub-lens 220, where the second sub-lens 220 is located between the first sub-lens 210 and the wavelength conversion element 130, and an optical effective diameter of the first sub-lens 210 is greater than an optical effective diameter of the second sub-lens 220, where the optical effective diameters may be, for example, a diameter of a body of the first sub-lens 210 and a diameter of a body of the second sub-lens 220. On the other hand, the light-splitting element 122 is disposed on the transmission path of the laser beam LI to guide the laser beam LI to the at least one lens 124. The laser beam L1 passes through the at least one lens 124 and is then transmitted to the wavelength conversion element 130. The light-splitting element 122 is, for example, a dichroic mirror that allows the laser beam LI to pass through and reflects light beams with a wavelength larger than the laser beam L1, but the invention is not limited thereto.

The wavelength conversion element 130 is disposed on the transmission path of the laser beam L1 from the at least one lens 124, and configured to reflect the laser beam LI back to the light-splitting element 122 and convert the laser beam L1 into an excited beam L2 and then reflect the excited beam L2 back to the light-splitting element 122. In detail, the wavelength conversion element 130 includes, for example, a metal substrate (not numbered), and the metal substrate has a wavelength conversion material (such as a phosphor material) thereon to convert the laser beam L1 into the excited beam L2 of different wavelengths. For example, in the embodiment, the wavelength conversion element 130 includes at least one wavelength conversion region and an optical region, where the at least one wavelength conversion region is configured to convert the laser beam LI into at least one excited beam (for example, a yellow beam or a green beam), and the optical region is configured to reflect the laser beam LI back to the light-splitting element 122. In the embodiment, the at least one conversion region is, for example, a yellow light conversion material, a green light conversion material, or a combination thereof, but the invention is not limited thereto. In addition, in the embodiment, the wavelength conversion element 130 is configured with a reflective layer (not shown) on the metal substrate, for example, to reflect the excited beam L2 and the laser beam LI back to the light-splitting element 122.

FIG. 3 is a schematic diagram of a light-splitting element according to an embodiment of the invention. Referring to FIG. 2 and FIG. 3, the light-splitting element 122 shown in FIG. 3 may be at least applied to the illumination system 100 shown in FIG. 2, which is taken as an example for description. It should be noted that at least one of the plurality of optical elements 120 (i.e., the light-splitting element 122, the at least one lens 124 or any combination thereof) includes a body 300 and a light-absorbing structure 310, and the body 300 has a central axis C1 (referring to FIG. 2). When the laser beam LI is incident on the body 300, a light spot is formed on the body 300. As shown in FIG. 3, the laser beam LI forms a light spot on, for example, a surface of the body 300 of the light-splitting element 122 facing the light source module 110, thereby defining a region where the light spot is located as a first region A1, where the first region A1 is located on one side of the central axis C1 of the body 300, and another side of the central axis C1 of the body 300 has the second region A2. In other words, when the illumination system 100 is operating, a temperature of the first region A1 will easily be higher than a temperature of the second region A2. The light-absorbing structure 310 is distributed on at least a part of an edge of the body 300 and are adjacent to the second area A2 (i.e., the region with lower temperature). For example, in the embodiment, at least one of the plurality of optical elements 120 is the light-splitting element 122, and the light-absorbing structure 310 is also distributed on the entire edge of the body 300, as shown in FIG. 3. In the embodiment, since the temperature of the second region A2 is lower than that of the first region A1, more light-absorbing structures 310 are coated near the edge of the second region A2. In this way, the overall temperature of the light-splitting element 122 is more balanced, which may avoid cracks caused by a temperature difference, thereby improving component stability and achieving good optical quality.

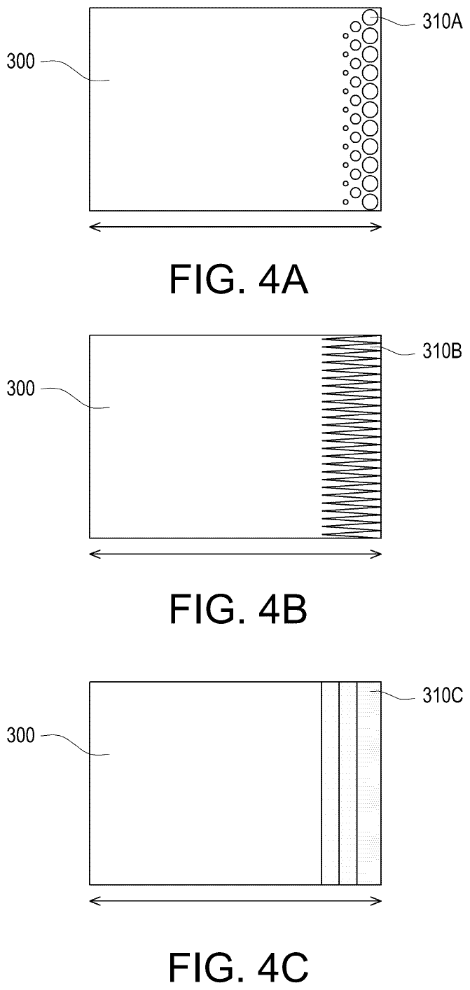

FIG. 4A to FIG. 4C are schematic diagrams of light-absorbing structures on the body according to different embodiments of the invention. Referring to FIG. 4A to FIG. 4C, in the embodiment, the light-absorbing structures 310A, 310B, and 310C may be formed on the body 300 by coating or sputtering with a dark-colored material to absorb stray light at a corresponding edge, and a distribution density of the light-absorbing structures 310A, 310B, and 310C gradually decreases from the edge of the body 300 toward the central axis of the body 300. The light-absorbing structure 310A, for example, adopts any pattern of different sizes (as shown in FIG. 4A), the light-absorbing structure 310B adopts a continuous pattern with varying areas (as shown in FIG. 4B), or the light-absorbing structure 310C adopts a coating concentration change to change a material density (as shown in FIG. 4C). In this way, the light-absorbing structure 310 may absorb stray light and increase a temperature of the corresponding edge, thus preventing the optical element from cracking due to the temperature difference, thereby improving the stability of the optical element and achieving good optical quality. In addition, the light-absorbing structure 310 may be, for example, high-temperature resistant paint, graphite coating, metal nitride, metal carbide, metal oxide, metal boride, other metal alloys and compounds, as long as a light absorption rate thereof is greater than 10%.

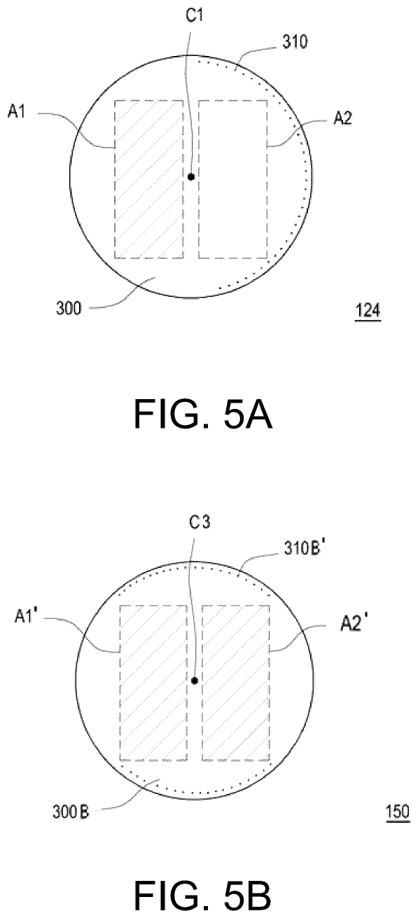

FIG. 5A is a schematic diagram of a light converging lens according to an embodiment of the invention. Referring to FIG. 2 and FIG. 5A, the at least one lens 124 shown in FIG. 5A may be at least applied to the illumination system 100 shown in FIG. 2, which is taken as an example for description. In another embodiment, when at least one of the plurality of optical elements is the at least one lens 124 (i.e., the first sub-lens 210 and/or the second sub-lens 220), the light-absorbing structure 310 is not distributed on at least another part of the edge of the body 300 of the at least one lens 124, and the at least one another part is adjacent to the first region A1. In other words, on the first sub-lens 210 and/or the second sub-lens 220, the light-absorbing structure 310 is only distributed on the edge of the second region A2 of the body 300, as shown in FIG. 5A. Therefore, the light-absorbing structure 310 may be used to increase a temperature of a relatively low-temperature area in the first sub-lens 210 and/or the second sub-lens 220, thereby preventing the first sub-lens 210 and/or the second sub-lens 220 from cracking due to the temperature difference.

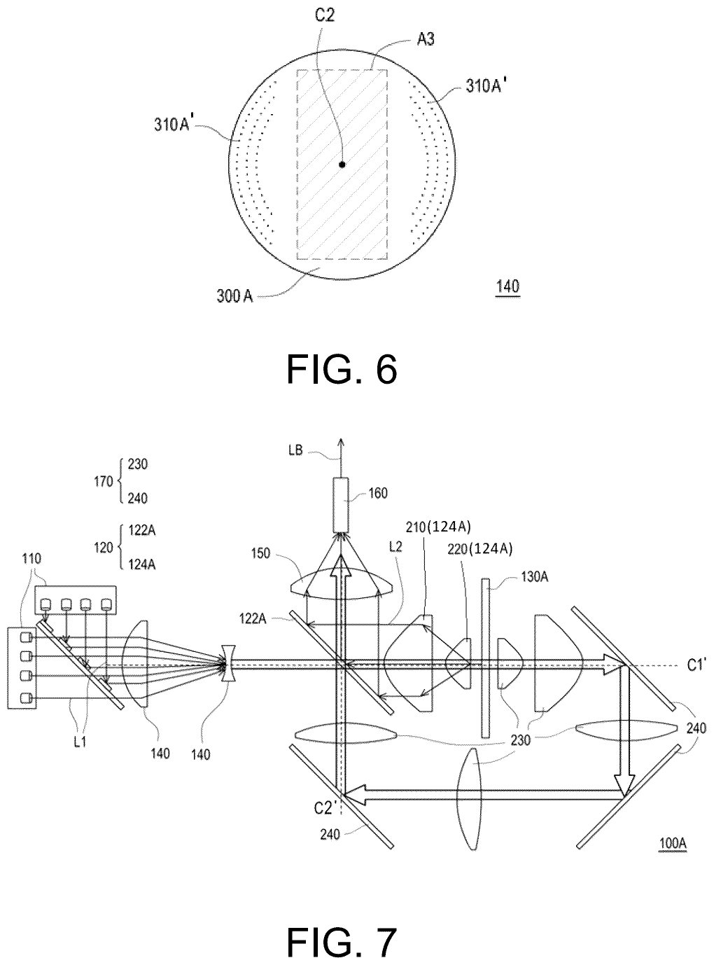

FIG. 6 is a schematic diagram of a collimating lens according to an embodiment of the invention. Referring to FIG. 2 and FIG. 6, the at least one collimating lens 140 shown in FIG. 6 may be at least applied to the illumination system 100 shown in FIG. 2, which is taken as an example for description. In another embodiment, the illumination system 100 further includes at least one collimating lens 140, which is disposed on the transmission path of the laser beam LI and is located between the light source module 110 and the light-splitting element 122. Specifically, in the embodiment, a number of the collimating lenses 140 is two, and each collimating lens 140 includes a body 300A and a light-absorbing structure 310A′. The light-absorbing structure 310A′ is distributed on at least a part of an edge of the body 300A. In detail, when the laser beam LI is incident on the body 300A along a central axis C2 of the body 300A of the two collimating lenses 140, a light spot is formed on the body 300A, and a region where the light spot is located is defined as a central region A3, and the light-absorbing structure 310A′ is only disposed on the edge of the body 300A away from the central region A3. As shown in the figure, the laser beam LI, for example, forms a light spot on a surface of the body of the collimating lens 140 facing the light source module 110. Specifically, in the embodiment, the central region A3 is, for example, a rectangle, and the light-absorbing structure 310A′ is disposed outside long sides of the rectangle, as shown in FIG. 6. The light-absorbing structure 310A′ of each collimating lens 140 is disposed on the body 300A in the same manner as that of the light-absorbing structure 310A (adopting arbitrary patterns of different sizes), the light-absorbing structure 310B (adopting a continuous pattern with varying areas), or the light-absorbing structure 310C (adopting a coating concentration change to change the material density) of FIG. 4A to FIG. 4C.

FIG. 5B is a schematic diagram of another light converging lens according to an embodiment of the invention. Referring to FIG. 2 together with FIG. 5B, a light converging lens 150 shown in FIG. 5B may be applied to the illumination system 100 shown in FIG. 2, which is taken as an example for description. In the embodiment of FIG. 2, the illumination system 100 further includes a light converging lens 150 and a light-uniformizing element 160. The light converging lens 150 is disposed on a transmission path of the excited beam L2 from the light-splitting element 122. The light-uniformizing element 160 is disposed on the transmission path of the excited light beam L2 and the laser beam LI from the light converging lens 150. The light converging lens 150 is disposed between the light-splitting element 122 and the light-uniformizing element 160. The light converging lens 150 includes a body 300B and a light-absorbing structure 310B′. When the laser beam LI is incident on the body 300B, a light spot is formed on the body 300B, and is located on both sides of a central axis C3 of the body 300B, and the regions where the light spot is located may be defined as a first region A1′ and a second region A2′, as shown in the figure, the laser beam L1, for example, forms a light spot on the surface of the body of the light converging lens 150 facing the light-splitting element 122. In the embodiment, the light-absorbing structure 310B′ of the condenser lens 150 is distributed on the body 300B away from short sides of the regions located at the both sides of the central axis C3, i.e., away from the short sides of the first region A1′ and the second region A2′. In this way, a temperature of a relatively low-temperature region in the light converging lens 150 may be increased through the light-absorbing structure 310B′, thereby preventing the light converging lens 150 from cracking due to the temperature difference. In the embodiment, the light-absorbing structure 310B′ of the light converging lens 150 is disposed on the body 300B in the same manner as that of the light-absorbing structure 310A (adopting arbitrary patterns of different sizes), the light-absorbing structure 310B (adopting a continuous pattern with varying areas), or the light-absorbing structure 310C (adopting a coating concentration change to change the material density) of FIG. 4A to FIG. 4C.

The light-uniformizing element 160 is configured to adjust a light spot shape of the illumination beam LB, so that the light spot shape of the illumination beam LB may match a shape (for example: a rectangle) of a working area of the light valve 60 (shown in FIG. 1), and the light spot has consistent or close light intensity everywhere, thereby uniformizing the light intensity of the illumination beam LB. The illumination beam LB includes, for example, at least one of the laser beam L1 and the excited beam L2 from the light-splitting element 122. In the embodiment, the light-uniformizing element 160 is, for example, an integrating rod. However, in other embodiments, the light-uniformizing element 160 may also be other appropriate types of optical elements, such as a lens array (a fly eye lens array), which is not limited by the invention.

FIG. 7 is a schematic diagram of an illumination system according to another embodiment of the invention. Referring to FIG. 7, an illumination system 100A shown in the embodiment is similar to the illumination system 100 shown in FIG. 2. The only difference between the embodiments is that in the embodiment, the wavelength conversion element 130A is a transmissive wavelength conversion color wheel, which is used to allow the laser beam LI to pass through and convert the laser beam L1 into the excited beam L2 and then reflect the excited beam L2 back to the light-splitting element 122A. In detail, in the embodiment, a plurality of optical elements (120, 140, 150) are arranged on the transmission path of the laser beam L1 and are located between the light source module 110 and the wavelength conversion element 130A. The plurality of optical elements (120, 140, 150) of the embodiment include a light-splitting element 122A (120), at least one first lens 124A (120), at least one second lens 140 and at least one third lens 150, where the at least one first lens 124A is located between the light-splitting element 122A and the wavelength conversion element 130A, the at least one second lens 140 is located between the light source module 110 and the light-splitting element 122A, and the at least one third lens 150 is located between the light-splitting element 122A and the light-uniformizing element 160. The light-splitting element 122A is disposed on the transmission path of the laser beam LI to guide the laser beam LI passing through the at least one second lens 140 to the at least one first lens 124A, and the laser beam LI passes through the at least one first lens 124A and is transmitted to the wavelength conversion element 130A. The wavelength conversion element 130A is disposed on the transmission path of the laser beam LI from the at least one first lens 124A. A wavelength conversion region of the wavelength conversion element 130A that has a wavelength conversion material is configured as a reflection region, for example, a reflection layer (not shown) is disposed under the wavelength conversion material, which is used to convert the laser beam L1 into the excited beam L2 and then reflect it back to the light-splitting element 122A. A region of the wavelength conversion element 130A without the wavelength conversion material is configured as a light transmission region, for example, a hole is drilled in the element or a glass light-transmitting component (not shown) is arranged in the light transmission region to allow the laser beam LI to pass through the wavelength conversion element 130A for transmitting to a light transmitting assembly 170, where the light transmitting assembly 170 is configured to guide the laser beam L1 to be transmitted back to the light-splitting element 122A to continue to pass through the at least one third lens 150 and the light-uniformizing element 160. In addition, in the embodiment, the at least one first lens 124A is also a light converging lens as that in the embodiment of FIG. 2, the at least one second lens 140 is also a collimating lens as that in the embodiment of FIG. 2, and the at least one third lens 150 is also a light converging lens as that in the embodiment of FIG. 2. Where, the light-absorbing structure of the at least one second lens 140 (collimating lens) is as shown in FIG. 6 (light-absorbing structure 310A′), which is only distributed on both sides of the first region (central area A3) of the body (the light-absorbing structure 310A′ is arranged outside the long sides of the rectangle).

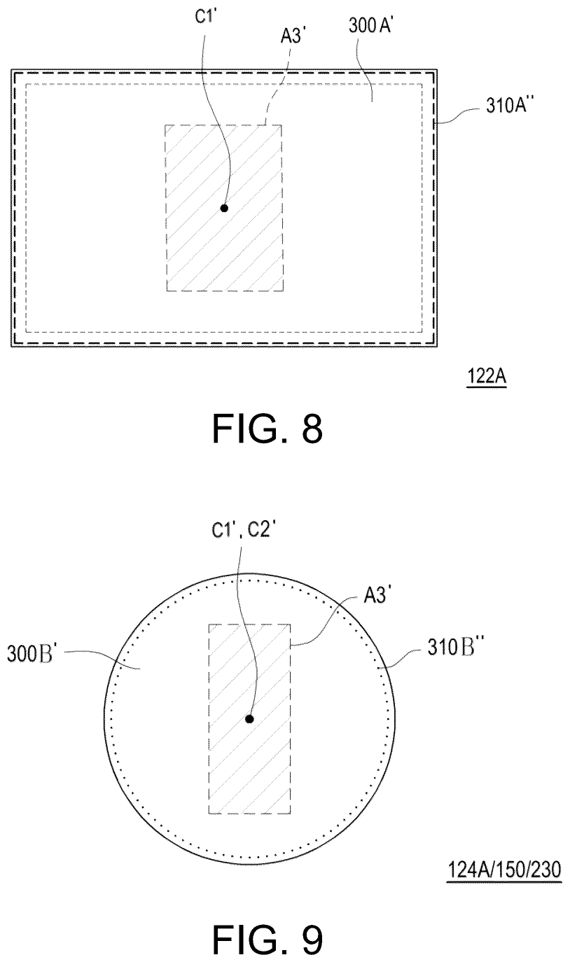

FIG. 8 is a schematic diagram of a light-splitting element according to another embodiment of the invention. Referring to FIG. 7 and FIG. 8, the light-splitting element 122A shown in FIG. 8 may be at least applied to the illumination system 100A shown in FIG. 7, which is taken as an example for description. It should be noted that in the illumination system 100A, since the wavelength conversion element 130A is a transmissive optical element, it may be further designed to transmit the laser beam LI into the body 300A′ along a central axis C1′ of the body 300A′ of the light-splitting element 122A to form a light spot on the body 300A′, and the region where the light spot is located is defined is a central region A3′, and a light-absorbing structure 310A″ is distributed on the entire edge of the body 300A′, as shown in FIG. 8. In this way, a temperature of an edge region of the light-splitting element 122A may be increased through the light-absorbing structure 310A″, thereby preventing the light-splitting element 122A from cracking due to the temperature difference. In the embodiment, the light-absorbing structure 310A″ of the light-splitting element 122A is disposed on the body 300A′ in the same manner as that of the light-absorbing structure 310A (adopting arbitrary patterns of different sizes), the light-absorbing structure 310B (adopting a continuous pattern with varying areas), or the light-absorbing structure 310C (adopting a coating concentration change to change the material density) of FIG. 4A to FIG. 4C.

FIG. 9 is a schematic diagram of a light converging lens according to another embodiment of the invention. Referring to FIG. 7 and FIG. 9, the first lens 124A or the third lens 150 shown in FIG. 9 may be at least applied to the illumination system 100A shown in FIG. 7, which is taken as an example for description. A central axis of the first lens 124A is C1′, and a central axis of the third lens is C2′. Since the laser beam LI is incident along the central axis C1′ of the body 300A′ of the light-splitting element 122A, the laser beam LI will also be incident to the body 300B′ along the central axis C1′ of the body 300B′ of the first lens 124A or along the central axis C2′ of the body 300B′ of the third lens 150, and form a light spot on the body 300B′, and the region where the light spot is located is defined is a central region A3′, and a light-absorbing structure 310B″ is distributed on the entire edge of the body 300B′, as shown in FIG. 9. In this way, a temperature of an edge region of the first lens 124A or the third lens 150 may be increased through the light-absorbing structure 310B″, thereby preventing the first lens 124A or the third lens 150 from cracking due to the temperature difference.

Referring to FIG. 7 and FIG. 9 again, a light transmitting lens 230 shown in FIG. 9 may be at least applied to the at least the lighting system 100A shown in FIG. 7, which is taken as an example for description. In the embodiment, the light transmitting assembly 170 includes, for example, a plurality of light transmitting lenses 230 and reflectors 240, which are used to change the transmission path of the laser beam LI and guide the laser beam LI back to the light-splitting element 122A, and the laser beam LI may pass through the light-splitting element 122A and is transmitted to the light-uniformizing element 160. It should be noted that in the embodiment, these light transmitting lenses 230 may have a similar design as that of the first lens 124A or the third lens 150, where the light-absorbing structure 310B″ is configured on the body 300B′, and the light-absorbing structure 310B″ is distributed on the entire edge of the body 300B′, as shown in FIG. 9. In this way, a temperature of an edge region of the light transmitting lens 230 may be increased through the light-absorbing structure 310B″, thereby preventing the light transmitting lens 230 from cracking due to the temperature difference. In the embodiment, the light-absorbing structure 310B″ of the first lens 124A, the third lens 150 or the light transmitting lens 230 is disposed on the body 300B′ in the same manner as that of the light-absorbing structure 310A (adopting arbitrary patterns of different sizes), the light-absorbing structure 310B (adopting a continuous pattern with varying areas), or the light-absorbing structure 310C (adopting a coating concentration change to change the material density) of FIG. 4A to FIG. 4C.

In summary, in the illumination system and projection device of the invention, the illumination system includes a light source module, a plurality of optical elements and a wavelength conversion element. The plurality of optical elements includes a light-splitting element and at least one lens, and at least one of the plurality of optical elements includes a body and a light-absorbing structure, and the light-absorbing structure is distributed on at least a part of the edge of the body. In this way, the light-absorbing structure may absorb stray light and increase a temperature of the corresponding edge, thereby preventing the optical element from cracking due to the temperature difference, and improving stability of the optical elements and achieving good optical quality.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination system, comprising a light source module, a plurality of optical elements and a wavelength conversion element, wherein:
the light source module is configured to provide a laser beam;
the plurality of optical elements are disposed on a transmission path of the laser beam and are located between the light source module and the wavelength conversion element, wherein the plurality of optical elements comprise a light-splitting element and at least one lens, wherein:
the at least one lens is located between the light-splitting element and the wavelength conversion element; and
the light-splitting element is disposed on the transmission path of the laser beam to guide the laser beam to the at least one lens, the laser beam passes through the at least one lens and is then transmitted to the wavelength conversion element;
the wavelength conversion element is disposed on the transmission path of the laser beam from the at least one lens, and is configured to reflect the laser beam back to the light-splitting element and convert the laser beam into an excited beam and then reflect the excited beam back to the light-splitting element;
wherein at least one of the light-splitting element and the at least one lens comprises a body and a light-absorbing structure, when the laser beam is incident to the body, a light spot is formed on the body, and a region where the light spot is located is defined as a first region, the first region is located at one side of a central axis of the body, and another side of the central axis of the body has a second region, wherein the light-absorbing structure is distributed on at least a part of an edge of the body, and the at least a part is adjacent to the second region.

2. The illumination system as claimed in claim 1, wherein the light-absorbing structure is distributed on the entire edge of the body of the light-splitting element.

3. The illumination system as claimed in claim 1, wherein the light-absorbing structure is not distributed on at least another part of the edge of the body of the at least one lens, and the at least another part is adjacent to the first region.

4. The illumination system as claimed in claim 1, wherein a distribution density of the light-absorbing structure gradually decreases from the edge of the body toward the central axis of the body.

5. The illumination system as claimed in claim 1, further comprising at least one collimating lens arranged on the transmission path of the laser beam and located between the light source module and the light-splitting element, wherein each of the at least one collimating lens comprises a body and a light-absorbing structure, and the light-absorbing structure is distributed on at least a part of an edge of the body.

6. The illumination system as claimed in claim 5, wherein when the laser beam is incident on the body along the central axis of the body, a light spot is formed on the body, and a region where the light spot is located is defined as a central region, and the light-absorbing structure is only disposed on the edge of the body away from the central region.

7. The illumination system as claimed in claim 1, further comprising a light converging lens disposed on a transmission path of the excited beam from the light-splitting element, the light converging lens comprises a body and a light-absorbing structure, when the laser beam is incident on the body, a light spot is formed in regions on both sides of the central axis of the body, and the light-absorbing structure is distributed on the body away from short sides of the regions located at the both sides of the central axis.

8. The illumination system as claimed in claim 7, further comprising a light-uniformizing element, wherein the light converging lens is disposed between the light-splitting element and the light-uniformizing element.

9. An illumination system, comprising a light source module, a plurality of optical elements, a wavelength conversion element and a light-uniformizing element, wherein:
the light source module is configured to provide a laser beam;
the plurality of optical elements are disposed on a transmission path of the laser beam and are located between the light source module and the wavelength conversion element, wherein the plurality of optical elements comprise a light-splitting element and a lens group, wherein:
the lens group comprises at least one first lens, at least one second lens and at least one third lens, wherein the at least one first lens is located between the light-splitting element and the wavelength conversion element, the at least one second lens is located between the light source module and the light-splitting element, and the at least one third lens is located between the light-splitting element and the light-uniformizing element; and
the light-splitting element is disposed on the transmission path of the laser beam to guide the laser beam passing through the at least one second lens to the at least one first lens, and the laser beam passes through the at least one first lens and is then transmitted to the wavelength conversion element;
the wavelength conversion element is disposed on the transmission path of the laser beam from the at least one first lens, and is configured to allow the laser beam to pass through and convert the laser beam into an excited beam and then reflect the excited beam back to the light-splitting element, the light-splitting element then guides the excited light beam to the at least one third lens and then to the light-uniformizing element;
wherein at least one of the light-splitting element and the lens group comprises a body and a light-absorbing structure, and when the laser beam is incident to the body, a light spot is formed on the body, and a region where the light spot is located is defined as a first region, wherein a central axis of the body passes through the first region, and the light-absorbing structure is distributed on an edge of the body away from the first region.

10. The illumination system as claimed in claim 9, wherein the light-absorbing structure is distributed on the entire edge of the body, or the light-absorbing structure is only distributed on both sides of the first region of the body.

11. The illumination system as claimed in claim 9, wherein a distribution density of the light-absorbing structure gradually decreases from the edge of the body toward the central axis of the body.

12. A projection device, comprising an illumination system, a light valve and a projection lens, wherein
the illumination system is configured to provide an illumination beam, the illumination system comprises a light source module, a plurality of optical elements and a wavelength conversion element, wherein
the light source module is configured to provide a laser beam;
the plurality of optical elements are disposed on a transmission path of the laser beam and are located between the light source module and the wavelength conversion element, wherein the plurality of optical elements comprise a light-splitting element and at least one lens, wherein;
the at least one lens is located between the light-splitting element and the wavelength conversion element; and
the light-splitting element is disposed on the transmission path of the laser beam to guide the laser beam to the at least one lens, and the laser beam passes through the at least one lens and is then transmitted to the wavelength conversion element;
the wavelength conversion element is disposed on the transmission path of the laser beam from the at least one lens, and is configured to reflect the laser beam back to the light-splitting element and convert the laser beam into an excited beam and then reflect the excited beam back to the light-splitting element;
wherein at least one of the light-splitting element and the at least one lens comprises a body and a light-absorbing structure, when the laser beam is incident to the body, a light spot is formed on the body, and a region where the light spot is located is defined as a first region, the first region is located at one side of a central axis of the body, and another side of the central axis of the body has a second region, wherein the light-absorbing structure is distributed on at least a part of an edge of the body, and the at least a part is adjacent to the second region;
the light valve is disposed on a transmission path of the illumination beam to convert the illumination beam into an image beam; and
the projection lens is disposed on a transmission path of the image beam and is configured to project the image beam out of the projection device.

13. The projection device as claimed in claim 12, wherein the light-absorbing structure is distributed on the entire edge of the body of the light-splitting element.

14. The projection device as claimed in claim 12, wherein the light-absorbing structure is not distributed on at least another part of the edge of the body of the at least one lens, and the at least another part is adjacent to the first region.

15. The projection device as claimed in claim 12, wherein a distribution density of the light-absorbing structure gradually decreases from the edge of the body toward the central axis of the body.

16. The projection device as claimed in claim 12, wherein the illumination system further comprises at least one collimating lens arranged on the transmission path of the laser beam and located between the light source module and the light-splitting element, wherein each of the at least one collimating lens comprises a body and a light-absorbing structure, and the light-absorbing structure is distributed on at least a part of an edge of the body.

17. The projection device as claimed in claim 16, wherein when the laser beam is incident on the body along the central axis of the body, a light spot is formed on the body, and a region where the light spot is located is defined as a central region, and the light-absorbing structure is only disposed on the edge of the body away from the central region.

18. The projection device as claimed in claim 12, wherein the illumination system further comprises a light converging lens disposed on a transmission path of the excited beam from the light-splitting element, the light converging lens comprises a body and a light-absorbing structure, when the laser beam is incident on the body, a light spot is formed in regions on both sides of the central axis of the body, and the light-absorbing structure is distributed on the body away from short sides of the regions located at the both sides of the central axis.

19. The projection device as claimed in claim 18, wherein the illumination system further comprises a light-uniformizing element, and the light converging lens is disposed between the light-splitting element and the light-uniformizing element.

20. A projection device, comprising an illumination system, a light valve and a projection lens, wherein:
the illumination system is configured to provide an illumination beam, and the illumination system comprises a light source module, a plurality of optical elements, a wavelength conversion element and a light-uniformizing element, wherein:
the light source module is configured to provide a laser beam;
the plurality of optical elements are disposed on a transmission path of the laser beam and are located between the light source module and the wavelength conversion element, wherein the plurality of optical elements comprise a light-splitting element and a lens group, wherein:
the lens group comprises at least one first lens, at least one second lens and at least one third lens, wherein the at least one first lens is located between the light-splitting element and the wavelength conversion element, the at least one second lens is located between the light source module and the light-splitting element, and the at least one third lens is located between the light-splitting element and the light-uniformizing element; and
the light-splitting element is disposed on the transmission path of the laser beam to guide the laser beam passing through the at least one second lens to the at least one first lens, and the laser beam passes through the at least one first lens and is then transmitted to the wavelength conversion element;
the wavelength conversion element is disposed on the transmission path of the laser beam from the at least one first lens, and is configured to allow the laser beam to pass through and convert the laser beam into an excited beam and then reflect the excited beam back to the light-splitting element, and the light-splitting element then guides the excited light beam to the at least one third lens and then to the light-uniformizing element;
wherein at least one of the light-splitting element and the lens group comprises a body and a light-absorbing structure, and when the laser beam is incident to the body, a light spot is formed on the body, and a region where the light spot is located is defined as a first region, wherein a central axis of the body passes through the first region, and the light-absorbing structure is distributed on an edge of the body away from the first region;
the light valve is disposed on a transmission path of the illumination beam to convert the illumination beam into an image beam; and
the projection lens is disposed on a transmission path of the image beam and is configured to project the image beam out of the projection device.

21. The projection device as claimed in claim 20, wherein the light-absorbing structure is distributed on the entire edge of the body, or the light-absorbing structure is only distributed on both sides of the first region of the body.

22. The projection device as claimed in claim 20, wherein a distribution density of the light-absorbing structure gradually decreases from the edge of the body toward the central axis of the body.
